(19) United States
(12) Patent Application Publication
(10) Pub. No.: US 2008/0129207 A1
(43) Pub. Date: Jun. 5, 2008

(54) Plasma device for liquid crystal alignment

(75) Inventors: Ru-Pin Chao, Hsinchu City (TW); Hsin-Ying Wu, Yilan City (TW); Chih-Chieh Wang, Banqiao City (TW); Shao-Ju Chang, Yonghe City (TW); Jenn-Chang Hwang, Hsin-Chu (TW); Chwung-Shan Kou, Hsinchu (TW); Kuen-Yi Wu, Tainan City (TW); An-Ping Lee, Keelung City (TW); Hsiao-Kuan Wei, Longtan Township (TW)

Correspondence Address: TROXELL LAW OFFICE PLLC, 5205 LEESBURG PIKE, SUITE 1404, FALLS CHURCH, VA, 22041, US

(73) Assignees: National Chiao Tung University, Hsinchu (TW); National Tsing Hua University, Hsinchu (TW)

(21) Appl. No.: 11/654,041

(22) Filed: Jan. 17, 2007

(30) Foreign Application Priority Data
Nov. 30, 2006 (TW) 095144561

(51) Int. Cl. H05H 1/46

(52) U.S. Cl. 315/111.21

(57) ABSTRACT

A device utilizes a plasma for a liquid crystal alignment. The alignment is processed in a vacuum chamber in a simple way. A general chemical vapor deposition is coordinated to reduce cost. The present invention is a novel contactless process avoiding particle contamination, residual static charge and scratch. And multiple are as of the present invention can be used for alignment.

### FIELD OF THE INVENTION

The present invention relates to liquid crystal alignment; more particularly, relates to utilizing a vacuum plasma system for bombarding an alignment film to obtain an aligned liquid crystal in a simple way and to be coordinated with a traditional chemical vapor deposition to reduce cost.

### DESCRIPTION OF THE RELATED ARTS

As early in 1911, C. Mauguin revealed a mechanical rubbing for aligning liquid crystals in a certain direction (C. Mauguin, Bull. Soc. Fr. Min. 34 (1911) 71.) This method is widely applied to liquid crystal displays now. A roller covered with velvet is used to rub the surfaces of alignment films, such as poly imide, polyvinyl alcohol or polyamide. This method aligns the liquid crystal; and, concerning chemical and heat stability, polyimide is the best choice for an alignment film. The mechanical rubbing needs only simple device and has a good yielding, so that the alignment of liquid crystal is mainly done by rubbing polyimide. However, this method is often used to rub a polymer like polyimide, which does not have a high hardness. And, moreover, the following disadvantages exist (S. Kobayashi, and Y. Iimura, SPIE, 123 (1994) 2175):

(a) Particle contamination is formed during rubbing.

(b) Scratches may be formed to damage the structure of the component.

(c) Static charge is formed on a surface of the polyimide so that the electrical lines of the lower layer may be harmed.

(d) A pretilt angle between the liquid crystal and the polyimide is hard to be controlled in its stability and uniformity.

(e) Unidirectional rubbing will cause the small viewing angle problem in the liquid crystal displays. However, in a small range of hundreds of micrometers, different alignment directions of liquid crystals to increase the viewing angle are difficult to be achieved.

For years, a new generation of alignment technology is developed. The new alignment method, which is called a non-contact alignment method, can give the liquid crystal alignment without contacting the alignment surfaces. There are a few methods belonged to this technology, like oblique bombardment by collimated ion beams, polarized UV irradiation of a polymer film, Langmuir-Blodgett film, oblique angle deposition of SiOₓ, oblique bombardment by collimated plasma beams, and micro-groove alignment.

Yet, the above methods is not yet widely used in the market place owing to cost, yielding or complexity. Hence, the prior arts do not fulfill users requests on actual use.

### SUMMARY OF THE INVENTION

The main purpose of the present invention is to utilize a vacuum plasma system for bombarding an aligning film to obtain an aligned liquid crystal in a simple way.

A second purpose of the present invention is to provide a novel contactless process avoiding particle contamination, residual static charge and scratch.

A third purpose of the present invention is to be coordinated with a traditional chemical vapor deposition to reduce cost.

To achieve the above purposes, the present invention is a plasma device for liquid crystal alignment, comprising a plasma source, an aligning substrate, a base, a vacuum chamber, a metal electrode, a gas inlet, a gas outlet and an impulse voltage generator, where the plasma source is a radio-frequency plasma source or a microwave plasma source; the metal electrode provides a negative impulse bias to the base; a tilted side wall of the base is deposed with the aligning substrate being fixed with a concave for avoiding slipping and the size of the concave is designed according to the size of the aligning substrate; the elevation angle for the base is controlled to obtain a best alignment and the elevation angle for the base is located between 0 and 90 degrees; and the base is applied with a negative impulse bias between 0 and 2000 volts to control a pre-tilted angle of a liquid crystal. Accordingly, a novel plasma device for liquid crystal alignment is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is the view showing the preferred embodiment according to the present invention;

FIG. 2 is the top-down view showing the base having a tilted side wall having a 30° elevation angle;

FIG. 3 is the side sectional view showing the base having the 30° tilted side wall;

FIG. 4 is the top-down view showing the base having a tilted side wall having a 60° elevation angle;

FIG. 5 is the side sectional view showing the base having the 60° tilted side wall;

FIG. 6 is the view showing the changes to the p re-tilted angle by the negative impulse bias;

FIG. 7 is the view showing the characteristics of various alignments.

### DESCRIPTION OF THE PREFERRED EMBODIMENT

The following description of the preferred embodiment is provided to understand the features and the structures of the present invention.

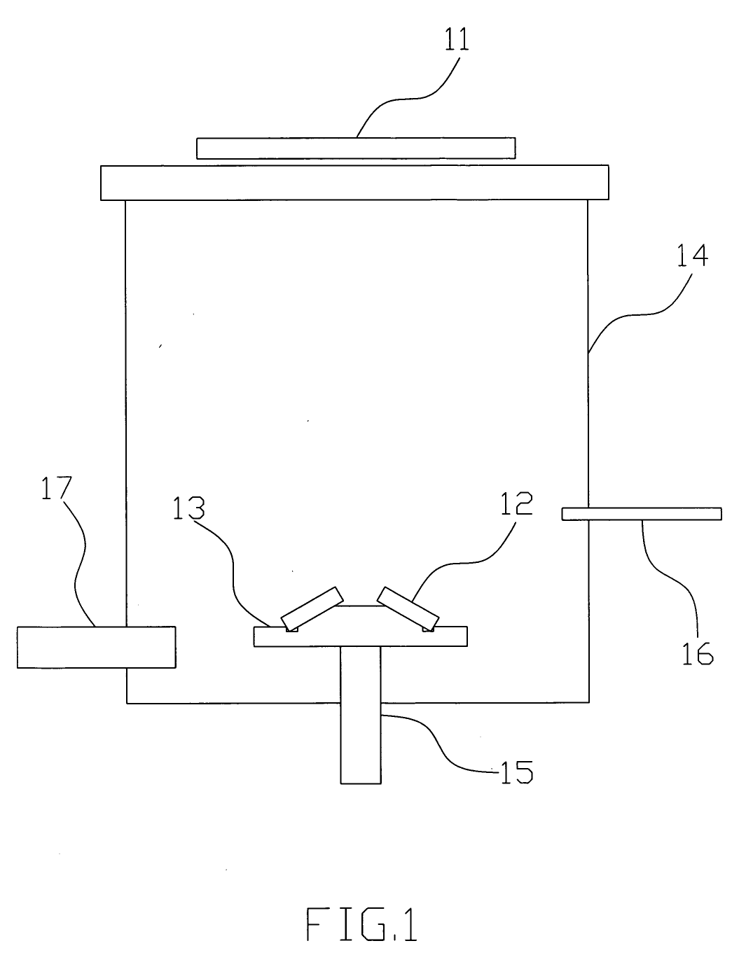

Please refer to FIG. 1, which is a view showing a preferred embodiment according to the present invention. As shown in the figure, the present invention is a plasma device for liquid crystal alignment, comprising a plasma source [11], an aligning substrate [12], a base [13], a vacuum chamber [14], a metal electrode [15], a gas inlet [16], a gas outlet [17] and an impulse voltage generator (not shown in the figure), where multiple are as are used for alignment and application of liquid crystal is improved.

The gas inlet [16] provides a gas to the vacuum chamber [14]; and, the gas is drawn out by a pump (not shown in the figure) through the gas outlet [17] to maintain a required gas pressure in the vacuum chamber [14]. The base [13] is located at bottom of the vacuum chamber [14]; and a tilted side wall of the base [13] is deposed with the aligning substrate [12] to be fix with a concave for avoiding slipping. The size of the concave is designed according to the size of the aligning substrate [12]. The base [13] is connected with the metal electrode [15] at an end; and the metal electrode [15] is connected with the impulse voltage generator to provide negative impulse bias to the base [13]. Therein, the plasma source [11] is a radio-frequency plasma source or a microwave plasma source; and the radio-frequency plasma source is an inductive coupling plasma source.

When using the present invention, an amorphous carbon with hydrogen (a-C:H) is used to be an alignment material; and 10 to 20 nm (nanometer) of a-C:H is deposed through a chemical vapor deposition (CVD) on a glass surface coated with indium tin oxide (ITO). The aligning film having the a-C:H is put in the vacuum chamber [14] and gas is pumped out to obtain a gas pressure of 5×10⁻⁶ torr. Then an argon gas or an oxygen gas is entered to obtain a gas pressure of 4.4×10⁻³ torr. The argon gas is processed to obtain a radio-frequency plasma with a power of 200 volts for 10 minutes (m in). After obtaining a plasma from the plasma source [11], the metal electrode [15] provides a 1000 volts negative impulse bias to the base [13] for obtaining a best alignment.

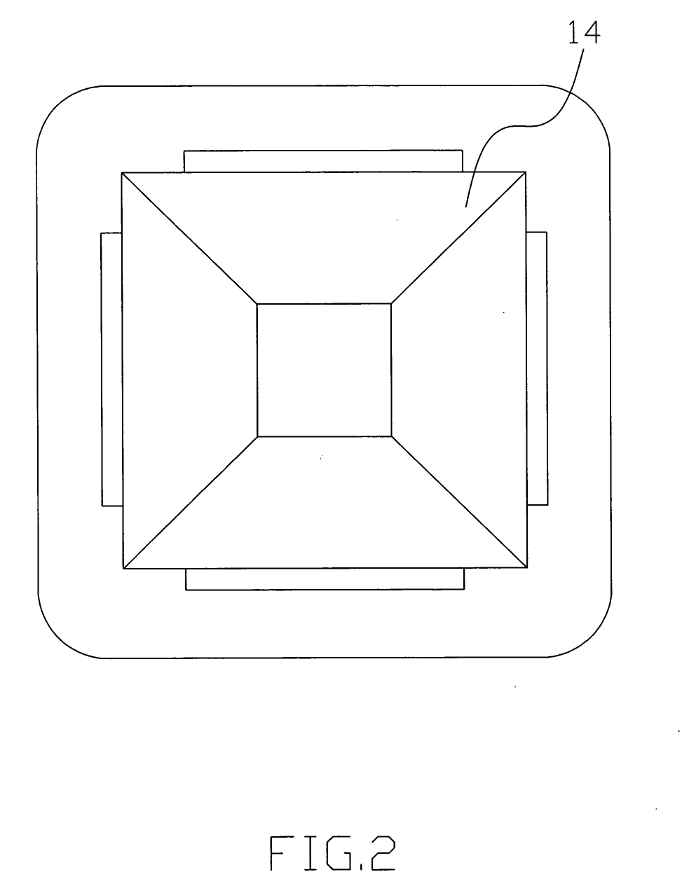

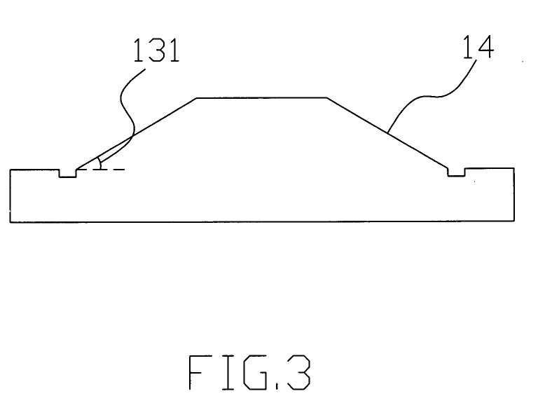

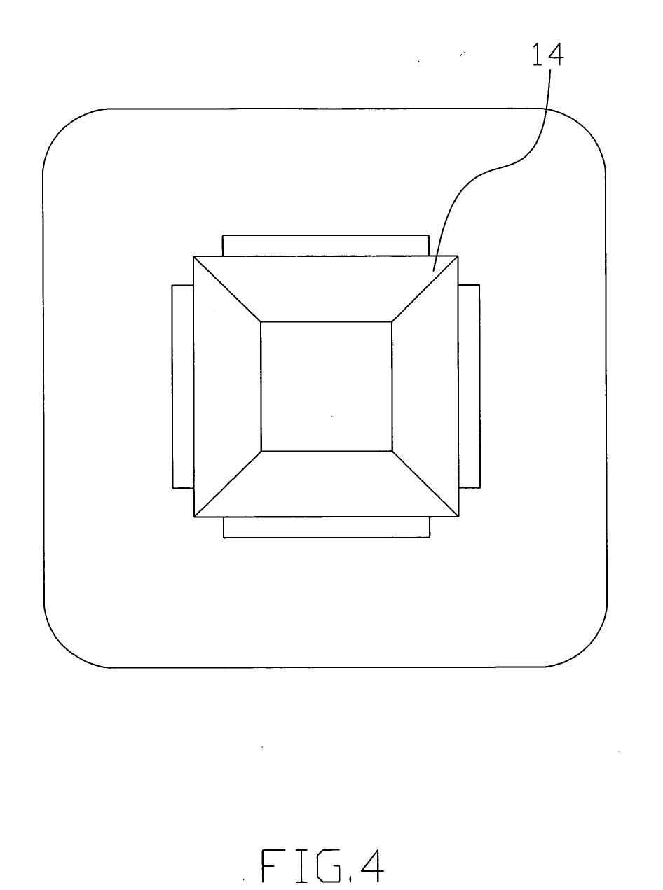

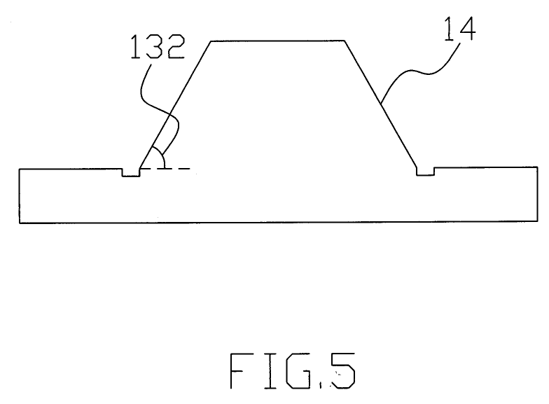

Please refer to FIG. 2 to FIG. 5, which are atop-down view and aside sectional view showing a base having a 30 degrees (°) elevation angle and a top-down view and a side sectional view showing a base having a 60° elevation angle. As shown in the figure, a base has a tilted side wall of 30° [131] or 60° [132]. When the tilted side wall has the 60° elevation angle [132], the alignment through the plasma is better than the alignment through the plasma to the tilted side wall having the 30° elevation angle [131]. And the design of the 60° elevation angle [132] obtains a high dark-state contrast ratio and is almost perfect. Thence, the present invention controls the elevation angle for the base [13] to obtain a best alignment, where the elevation angle for the base [13] is located between 0 and 90 degrees.

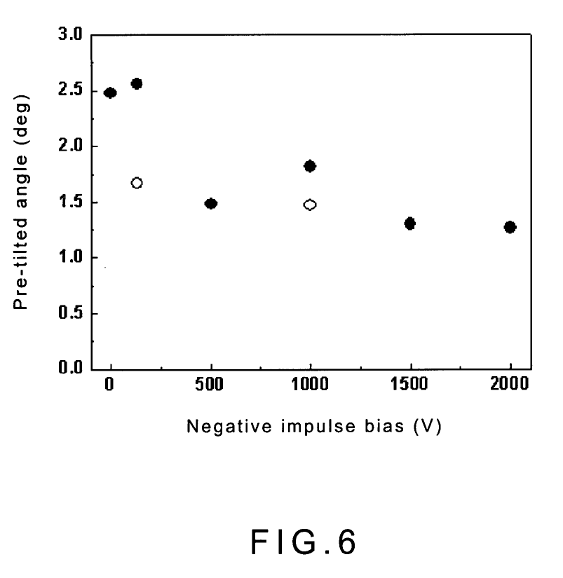

Please refer to FIG. 6, which is a view showing changes to a pre-tilted angle by a negative impulse bias. As shown in the figure, the present invention controls a negative impulse bias applied to a base to control a pre-tilted angle of a liquid crystal. An argon plasma is obtained under 200 volts of a radio-frequency power and an alignment is processed for 10 min.

In the 10 min, the pre-tilted angle changes following a negative impulse bias applied to the base being varied from 0 to 2000 volts. And the pre-tilted angle is getting smaller as the applied negative impulse bias increases; and reaches a saturation of 1.0° to 1.5° by a negative 500 volts.

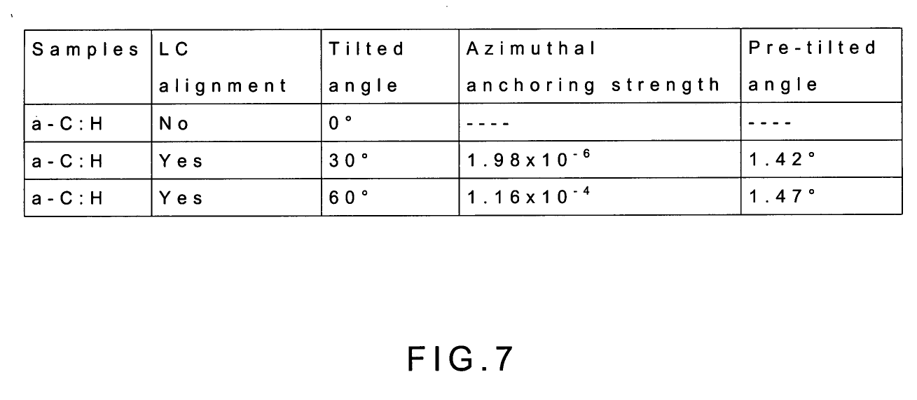

Please refer to FIG. 7, which is a view showing characteristics of various alignments. As shown in the figure when a base has a 60° elevation angle, an azimuthal anchoring strength is obtained as 1.16×10⁻⁴ J/m², which is close to an azimuthal anchoring strength of about 10⁻³ J/m² for an alignment of a polyimide film by brushing. Hence the present invention is applied in industry.

Nevertheless, when the elevation angle is 0°, no alignment is obtained through the argon plasma. When the elevation angle is 30°, certain alignment is obtained through the argon plasma. Yet, when the elevation angle is 60°, excellent alignment is obtained through the argon plasma which has a high dark-state contrast ratio of the liquid crystal and is almost perfect. As a result, the present invention obtains a best alignment through adjusting an elevation angle for a base.

To sum up, the present invention is a plasma device for liquid crystal alignment, where a general vacuum plasma system is used for bombarding an aligning film to obtain an aligned liquid crystal in a simple way; a traditional CVD is coordinated to reduce cost; and the present invention is a novel contactless process avoiding particle contamination, residual static charge and scratch and alignment for multiple areas is achieved.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A plasma device for liquid crystal alignment, comprising:
a plasma source;
an aligning substrate, said aligning substrate being deposed with an alignment film;
a base, said base being deposed with said aligning substrate;
a vacuum chamber, said vacuum chamber being deposed with said base at bottom of said vacuum chamber;
a gas inlet, said gas inlet providing a gas to said vacuum chamber;
a gas outlet, said gas outlet drawing said gas out of said vacuum chamber;
a metal electrode, said metal electrode providing a negative impulse bias to said base; and
an impulse voltage generator.

2. The device according to claim 1
wherein said plasma source is selected from a group consisting of a radio-frequency plasma source and a microwave plasma source.

3. The device according to claim 2,
wherein said radio-frequency plasma source is an inductive coupling plasma source.

4. The device according to claim 1,
wherein said base is connected to said metal electrode at an end of said base.

5. The device according to claim 1,
wherein said base has a tiled angle and said tiled angle is located between 0 and 90 degrees.

6. The device according to claim 1,
wherein said base is applied with a negative impulse bias to control a pre-tilted angle of a liquid crystal.

7. The device according to claim 6,
wherein said negative impulse bias is located between 0 and 2000 volts.

8. The device according to claim 1,
wherein said gas is selected from a group consisting of argon gas and oxygen gas.

9. The device according to claim 1
wherein said metal electrode is connected with said impulse voltage generator.
